(19) United States
(12) Patent Application Publication
(10) Pub. No.: US 2006/0085607 A1
(43) Pub. Date: Apr. 20, 2006

(54) Method of introducing a storage system, program, and management computer

(76) Inventor: Toshiyuki Haruma, Yokohama (JP)

Correspondence Address: Mattingly, Stanger & Malur, P.C., Suite 370, 1800 Diagonal Road, Alexandria, VA, 22314, US

(21) Appl. No.: 11/013,538

(22) Filed: Dec. 17, 2004

(30) Foreign Application Priority Data
Oct. 15, 2004 (JP) 2004-301962

(51) Int. Cl. G06F 12/16

(52) U.S. Cl. 711/161; 711/162

(57) ABSTRACT

Access right is changed in a manner that allows a storage system (3) connected to a network access to an existing storage system (2). A path is detected for a volume set in the existing storage system (2), and when a volume is found that has no path defined, a path accessible to the new storage system is set to the existing storage system (2). A volume of the existing storage system (2) is allocated to the new storage system (3). A path is defined in a manner that allows a host computer access to the existing storage system (2). Data of the existing storage system (2) is duplicated to the volume allocated to the new storage system (3).

### CROSS-REFERENCE TO PRIOR APPLICATION

This application relates to and claims priority from Japanese Patent Application No.2004-301962 filed on Oct. 15, 2004, the entire disclosure of which is incorporated herein by reference.

### BACKGROUND

This invention relates to a method of newly introducing a storage system into a computer system including a first storage system and a host computer accessing the first storage system, a migration method thereof, and a migration program therefor.

Recently, an amount of data handled by a computer is increasing in leaps, and accordingly storage capacity of a storage system for storing data is increasing. As a result, costs of storage management in system management have increased, and reduction of management costs have become an important issue from the viewpoint of system operation.

When a new storage system is to be introduced into an existing computer system that includes a host computer and a storage system, two modes can be considered as a mode of introduction, namely, a mode in which a new storage system is used together with the old storage system, and a mode in which all the data on the old storage system is moved to the new storage system.

For example, as to the above mode of introduction, JP 10-508967 A discloses a technique of migrating data of an old storage system onto the volume allocated to a new storage system. According to the technique disclosed in JP 10-508967 A, the volume of data in the old storage system is moved to the new storage system. Then, a host computer's access destination is changed from the volume of the old storage system to the volume of the new storage system, and an input-output request from the host computer to the existing volume is received by the volume of the new storage system. With respect to a read request, a part that has been moved is read from the new volume, while a part that has not yet been moved is read from the existing volume. Further, with respect to a write request, dual writing is performed toward both the first and second devices.

### SUMMARY

As described above, when a new storage system is introduced, it is possible to migrate the volume of data within an old storage system to a new storage system without stopping input/output from/to a host computer.

However, in the case of the above conventional mode of introduction, where the new storage system and the old storage system are used side by side, there is a problem that, although generally the new storage system has high functionality, high performance, and high reliability in comparison with the old storage system, it is impossible for data stored in the old storage system to enjoy the merits of the new storage system.

A problem of the latter conventional example where all data in the old storage system is to be moved to the new storage system is that some of volumes in the old storage system to which no paths are set cannot be moved.

Furthermore, while data can be moved from the old to new storage systems, there is no way to transplant inter-volume connection configurations such as pair volume of the old storage system in the new storage system.

It is therefore an object of this invention to make it possible to move all data from an existing storage system to a new storage system and transplant inter-volume connection configurations of the old storage system in the new storage system.

According to an embodiment of this invention, there is provided a storage system introducing method for introducing a second storage system to a computer system including a first storage system and a host computer, the first storage system being connected to a network, the host computer accessing the first storage system via the network, the method including the steps of: changing access right of the first storage system in a manner that allows the newly connected second storage system access to the first storage system; detecting a path for a volume set in the first storage system; setting, when a volume without the path is found, a path that is accessible to the second storage system to the first storage system; allocating a volume of the first storage system to the second storage system; defining a path in a manner that allows the host computer access to a volume of the second storage system; and transferring data stored in a volume of the first storage system to the volume allocated to the second storage system, in which a management computer is instructed to execute the above-mentioned steps, and setting of the host computer is changed to forward an input/output request made to the first storage system by the host computer to the second storage system.

According to this invention, data can easily be moved from volumes of the existing first storage system to the introduced second storage system irrespective of whether the volumes are ones which are actually stored in the first storage systems and to which paths are set or ones to which no paths are set. The labor and cost to introduce a new storage system is thus minimized.

In addition, this invention makes it possible to transplant, with ease, inter-volume connection configurations such as pair volume and migration volume of the existing storage system in the introduced storage system. Introducing a new storage system is thus facilitated.

### BRIEF DESCRIPTION OF THE DRAWINGS

FIG. 1 is a computer system configuration diagram showing an embodiment of this invention.

FIG. 2 is a configuration diagram showing an example of volume management information used by a disk controller to manage a volume in a storage system.

FIG. 3 is a configuration diagram showing an example of RAID management information used by the disk controller to manage a physical device in the storage system.

FIG. 4 is a configuration diagram of external device management information used by the disk controller to manage an external device of the storage system.

FIG. 5 is an explanatory diagram showing an example of storage system management information which is owned by a storage manager in a management server.

FIG. 6 is an explanatory diagram showing an example of path management information which is owned by the storage manager in the management server and which is prepared for each storage system.

FIG. 7 is a configuration diagram of volume management information which is owned by the storage manager in the management server and which is prepared for each storage system to show the state of each volume in the storage system.

FIG. 8 is an explanatory diagram of inter-volume connection management information which is owned by the storage manager in the management server and which is prepared for each storage system to show the connection relation between volumes in the storage system.

FIG. 9 is an explanatory diagram of external connection management information which is owned by the storage manager in the management server and which is prepared for each storage system to show the connection relation between a volume in the storage system and an external storage system.

FIG. 10 is an explanatory diagram of port management information which is owned and used by the storage manager in the management server to manage ports of each storage system.

FIG. 11 is a flow chart showing an example of introduction processing executed by the storage manager.

FIG. 12 is a flow chart showing a subroutine for data migration.

FIG. 13 is a flow chart showing a subroutine for pair volume migration.

FIG. 14 is a flow chart showing a subroutine for migration volume migration.

FIG. 15 is an explanatory diagram showing an example of a temporary path definition given to a volume to which no path is set.

FIG. 16 is an explanatory diagram showing how data and inter-volume connection configurations are moved to a new storage system from an existing storage system.

FIG. 17 is an explanatory diagram of a new volume management information created from an old volume management information upon migration between storage systems.

FIG. 18 is an explanatory diagram of a new path management information created from an old path management information upon migration between storage systems.

FIG. 19 is an explanatory diagram showing a change in volume management information upon migration of pair volumes and migration volumes.

### DETAILED DESCRIPTION OF THE PREFERRED EMBODIMENTS

An embodiment of this invention will be described below with reference to the accompanying drawings.

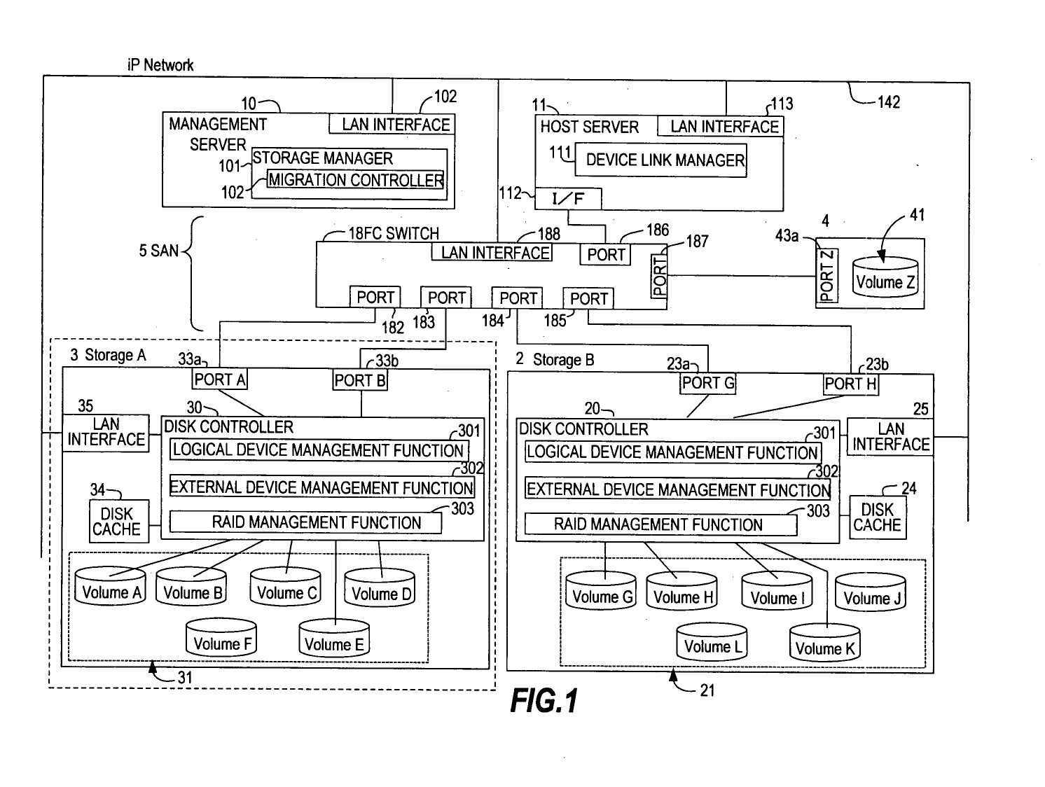

FIG. 1 is a configuration diagram of a computer system to which this invention is applied. A host server (computer) 11 is connected to storage systems 2 and 4 via a SAN (Storage Area Network) 5, which includes a Fibre Channel switch (hereinafter referred to as “FC switch”) 18. Shown here is an example of adding a new storage system 3 (surrounded by the broken line in FIG. 1) to the existing storage systems 2 and 4 and moving data in the old storage system 2 (first storage system) to the new storage system 3 (second storage system).

The host server 11, the storage systems 2 to 4, and the FC switch 18 are connected via a LAN (IP network) 142 to a management server 10, which manages the SAN 5.

The host server 11 includes a CPU (not shown), a memory, and the like, and performs predetermined functions when the CPU reads and executes an operating system (hereinafter, “OS”) and application programs stored in the memory.

While the storage systems 2 and 4 are existing storage systems, the storage system 3 is a newly introduced storage system. The storage system 2 (storage system B in the drawing) has a disk unit 21, a disk controller 20, ports 23a and 23b (ports G and H in the drawing), which connect the storage system 2 with the SAN 5, a LAN interface 25, which connects the storage system 2 with the LAN 142, and a disk cache 24 where data to be read from and written in the disk unit 21 is temporarily stored. The storage system 4 is similarly structured except that it has a disk unit 41 and a port 43a (port Z in the drawing), which connects the storage system 4 with the SAN 5.

The newly added storage system 3 has plural disk units 31, a disk controller 30, ports 33a and 33b (ports A and B in the drawing), which connect the storage system 3 with the SAN 5, a LAN interface 35, which connects the storage system with the LAN 142, and a disk cache 34 where data to be read from and written in the disk units 31 is temporarily stored.

In storage systems 2 to 4 of this embodiment, the disk unit 21 (or 31, 41) as hardware is defined collectively as one or a plurality of physical devices, and one logical device from a logical viewpoint, i.e., volume (logical volume), is assigned to one physical device. Of course, it is possible to present the individual disk unit 21 as one physical device and one logical device, to the host server 11.

Further, as the ports 23a to 43a of the storage systems 2 to 4, it is assumed that a Fibre Channel interface whose upper protocol is SCSI (Small Computer System Interface) is used. However, another network interface for storage connection, such as IP network interface whose upper protocol is SCSI, may also be used.

The disk controller 20 of the storage system 2 includes a processor, the cache memory 24, and a control memory, and communicates with the management server 10 through the LAN interface 25 and controls the disk unit 21. The processor of the disk controller 20 accesses from the host server 11 and controls the disk unit 21, based on various kinds of information stored in the control memory. In particular, in the case where, as in a disk array, a plurality of disk units 21, rather than a single disk unit 21, are presented as one or plurality of logical devices to the host server 11, the processor performs processing and management relating to the disk units 21. Furthermore, the control memory (not shown) stores programs executed by the processor and various kinds of management information. As one of the programs executed by the processor, there is a disk controller program.

Further, as the various kinds of management information stored or to be stored in the control memory, there are logical device management information 201 for management of the volume of the storage system 2; RAID (Redundant Array of Independent Disks) management information 203 for management of physical devices consisting of the plurality of disk units 21 of the storage system 2, and external device management information 202 for managing which volume of the storage system 2 is associated with which volume of the storage system 4.

To enhance processing speed for an access from the host server 11, the cache memory 24 of the disk controller 20 stores data that are frequently read, or temporarily stores write data from the host server 11.

The storage system 4 is structured the same way the storage system 2 is built, and is controlled by a disk controller (not shown) or the like.

The newly added storage system 3 is similar to the existing storage system 2 described above. The disk controller 30 communicates with the host server 11 and others via the ports 33a and 33b, utilizes the cache memory 34 to access the disk units 31, and communicates with the management server 10 via the LAN interface 35. As the disk controller 20 does, the disk controller 30 executes a disk controller program and has, in a control memory (not shown), logical device management information 301, RAID management information 303 and external device management information 302. The logical device management information 301 is for managing volumes of the storage system 3. The RAID management information 303 is for managing a physical device that is constituted of the plural disk units 31 of the storage system 3. The external device management information 302 is for managing which volume of the storage system 3 is associated with which volume of an external storage system.

The host server 11 is connected to the FC switch 18 through an interface (I/F) 112, and also to the management server 10 through a LAN interface 113. Software (a program) called a device link manager (hereinafter, “DLM”) 111 operates on the host server 11. The DLM 111 manages association between the volumes of each of the storage systems recognized through the interface 112 and device files as device management units of the OS (not shown). Usually, when a volume is connected to a plurality of interfaces 112 and a plurality of ports 23a and 23b, the host server 11 recognizes that volume as a plurality of devices having different addresses, and different device files are defined, respectively.

A plurality of device files corresponding to one volume are managed as a group by the DLM 111, and a virtual device file as a representative of the group is provided to upper levels, so alternate paths and load distribution can be realized. Further, in this embodiment, the DLM 111 also adds/deletes a new device file to/from a specific device file group and changes a main path within a device file group according to an instruction from a storage manager 101 located in the management server 10.

The management server 10 performs operation, maintenance, and management of the whole computer system. The management server 10 comprises a LAN interface 133, and connects to the host server 11, storage systems 2 to 4, and the FC switch 18 through the LAN network 142.

The management server 10 collects configuration information, resource utilization factors, and performance monitoring information from various units connected to SAN 5, displays them to a storage administrator, and sends operation/maintenance instructions to those units through the LAN 142. The above processing is performed by the storage manager 101 operating on the management server 10.

As in the above disk controller 20, the storage manager 101 is executed by a processor and a memory (not shown) in the management server 10. The memory stores a storage manager program to be executed by the processor. This storage manager program includes an introduction program for introducing a new storage system. This introduction program and the storage manager program including it are executed by the processor to function as a migration controller 102 and the storage manager 101, respectively. It should be noted that, when a new storage system 3 or the like is to be introduced, this introduction program is installed onto the existing management server 10, except the case where a new management server incorporated with the introduction program is employed.

The FC switch 18 has plural ports 184 to 187, to which the ports 23a, 23b, 33a, 33b, and 43a of the storage systems 2 to 4, and the FC interface 112 of the host server 11 are connected enabling the storage systems and the server to communicate with one another. The FC switch 18 is connected to the LAN 142 via a LAN interface 188.

Due to this arrangement, from the physical viewpoint, any host server 11 can access all the storage systems 2 to 4 connected to the FC switch 18. Further, the FC switch 18 has a function called zoning, i.e., a function of limiting communication from a specific port to another specific port. This function is used, for example, when access to a specific port of a specific storage is to be limited to a specific host server 11. Examples of a method of controlling combinations of a sending port and a receiving port include a method in which an identifier assigned to a port 182 to 187 of the FC switch 18 is used, and a method in which WWN (World Wide Name) held by the interface 112 of each host server 11 and a port 123 of storage systems 2 to 4.

Next, there will be described the volume management information 201, the RAID management information 203 and the external device management information 202 stored or to be stored in the control memory of the disk controller 20 of the storage system 2 which is the origin of migration.

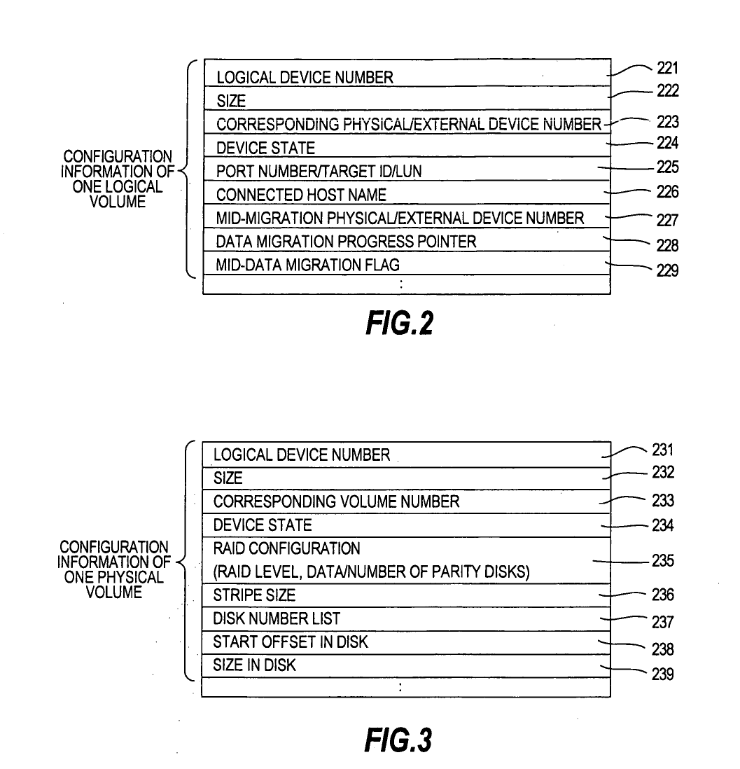

FIG. 2 is a configuration diagram showing an example showing the volume management information 201 for management of the volume within the storage system 2 of the disk controller 20.

The logical volume management information 201 includes a volume number 221, a size 222, a corresponding physical/external device number 223, a device state 224, a port ID/target ID/LUN (Logical Unit number) 225, a connected host name 226, a mid-migration/external device number 227, a data migration progress pointer 228, and a mid-data migration flag 229.

The size 222 stores the capacity of the volume, i.e., the volume specified by the volume number 221. The corresponding physical/external device number 223 stores a physical device number corresponding to the volume in the storage system 2, or stores an external device number, i.e., a logical device of the storage system 4 corresponding to the volume. In the case where the physical/external device number 223 is not assigned, an invalid value is set in that entry. This device number becomes an entry number in the RAID management information 203 or the external device management information. The device state 224 is set with information indicating a state of the volume.

The device state can be “online”, “offline”, “unmounted”, “fault offline”, or “data migration in progress”. The state “online” means that the volume is operating normally, and can be accessed from an upper host. The state “offline” means that the volume is defined and is operating normally, but cannot be accessed from an upper host. This state corresponds to a case where the device was used before by an upper host, but now is not used by the upper host since the device is not required. Here, the phrase “the volume is defined” means that association with a physical device or an external device is set, or specifically, the physical/external device number 223 is set. The state “unmounted” means that the volume is not defined and cannot be accessed from an upper host. The state “fault offline” means that a fault occurs in the volume and an upper host cannot access the device. Further, the state “data migration in progress” means that data migration from or to an external device is in course of processing.

For the sake of simplicity, it is assumed in this embodiment that, at the time of shipping of the product, available volumes were assigned in advance to physical devices prepared on a disk unit 21. Accordingly, an initial value of the device state 224 is “offline” with respect to the available volumes, and “unmounted” with respect to the other at the time of shipping of the product.

The port number of the entry 225 is set with information indicating which port the volume is connected to among the plurality of ports 23a and 23b. As the port number, a number uniquely assigned to each of the ports 23a and 23b within the storage system 2 is used. Further, the target ID and LUN are identifiers for identifying the volume.

The connected host name 226 is information used only by the storage systems 2 to 4 connected to the FC switch 18, and shows a host name for identifying a host server 11 that is permitted to access the volume. As the host name, it is sufficient to use a name that can uniquely identify a host server 11 or its interface 112, such as a WWN given to the interface 112 of a host server 11. In addition, the control memory of the storage system 2 holds management information on an attribute of a WWN and the like of each of the ports 23a and 23b.

When the device state 224 is “data migration in progress”, the mid-migration/external device number 227 holds a physical/external device number of a migration destination of the physical/external device to which the volume is assigned. The data migration progress pointer 228 is information indicating the first address of a migration source area for which migration processing is unfinished, and is updated as the data migration progresses. The mid-data migration flag 229 has an initial value “Off”. When the flag 229 is set to “On”, it indicates that the physical/external device to which the volume is assigned is under data migration processing. Only in the case where the mid-data migration flag is “On”, the mid-migration/external device number 227 and the data migration progress pointer 228 become effective.

The disk controller 30 of the storage system 3 has the logical device management information 301 which is similar to the logical device management information 201 described above. The storage system 4 (not shown) also has logical device management information.

FIG. 3 is a diagram showing an example configuration of the RAID management information 203 for management of the physical devices within the storage system 2. The RAID management information 203 includes a physical device number 231, a size 232, a corresponding volume number 233, a device state 234, a RAID configuration 235, a stripe size 236, a disk number list 237, start offset in disk 238, and size in disk 239.

The size 232 stores capacity of the physical device, i.e., the physical device specified by the physical device number 231. The corresponding volume number 233 stores a volume number of the logical device corresponding to the physical device, within the storage system 2. In the case where the physical device is not assigned with a volume, this entry is set with an invalid value. The device state 234 is set with information indicating a state of the physical device. The device state includes “online”, “offline”, “unmounted”, and “fault offline”. The state “online” means that the physical device is operating normally, and is assigned to a volume. The state “offline” means that the physical device is defined and is operating normally, but is not assigned to a volume. Here, the phrase “the physical device is defined” means that association with the disk unit 21 is set, or specifically, the below-mentioned disk number list 237 and the start offset in disk are set. The state “unmounted” means that the physical device is not defined on the disk unit 21. The state “fault offline” means that a fault occurs in the physical device, and the physical device cannot be assigned to a volume.

For the sake of simplicity, in this embodiment, physical devices have been prepared in advance on the disk unit 21 at the time of shipping of the product. Accordingly, an initial value of the device state 234 is “offline” with respect to the available physical devices, and “unmounted” with respect to the other.

The RAID configuration 235 holds information on a RAID configuration, such as a RAID level and the numbers of data disks and parity disks, of the disk unit 21 to which the physical device is assigned. Similarly, the stripe size 236 holds data partition unit (stripe) length in the RAID. The disk number list 237 holds a number or numbers of one or a plurality of disk units 21 constituting the RAID to which the physical device is assigned. These numbers are unique values given to disk units 21 for identifying those disk units 21 within the storage system 2. The start offset in disk 237 and the size in disk 238 are information indicating an area to which data of the physical device are assigned in each disk unit 21. In this embodiment, for the sake of simplicity, the respective offsets and sizes in the disk units 21 constituting the RAID are unified.

Each entry of the above-described RAID management information 203 is set with a value, at the time of shipping the storage system 3.

The disk controller 30 of the storage system 3 has the RAID management information 303 which is similar to the RAID management information 203 described above. The storage system 4 (not shown) also has RAID management information.

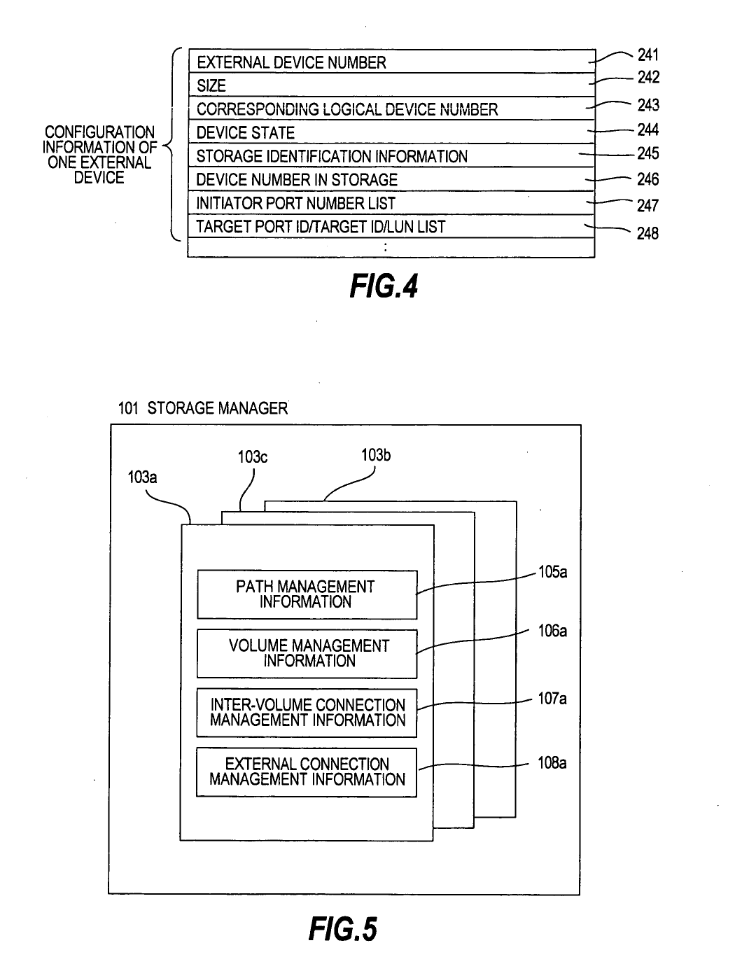

FIG. 4 is a diagram showing an example configuration of the external device management information 202 of the storage system 2 that manages the external device.

The external device management information 202 includes an external device number 241, a size 242, a corresponding logical device number 243, a device state 244, a storage identification information 245, a device number in storage 246, an initiator port number list 247, and a target port ID/target ID/LUN list 248.

The external device number 241 holds a value assigned to a volume of the storage system 2, and this value is unique in the storage system 2. The size 242 stores capacity of the external device, i.e., the external device specified by the external device number 241. When the external device corresponds to a volume number in the storage system 3, the corresponding logical volume number 243 is stored. When the external device is not assigned to a volume, this entry is set with an invalid value. The device state 244 is set with information indicating a state of the external device. The device state 244 is “online”, “offline”, “unmounted” or “fault offline”. The meaning of each state is same as the device state 234 in the RAID management information 203. In the initial state of the storage system 3, another storage system is not connected thereto, so the initial value of the device state 244 is “unmounted”.

The storage identification information 245 holds identification information of the storage system 2 that carries the external device. As the storage identification information, for example, a combination of vendor identification information on a vendor of the storage system 2 and a manufacturer's serial number assigned uniquely by the vendor may be considered.

The device number in storage 246 holds a volume number in the storage system 2 corresponding to the external device. The initiator port number list 247 holds a list of port numbers of ports 23a and 23b of the storage system 2 that can access the external device. When, with respect to the external device, LUN is defined for one or more of the ports 23a and 23b of the storage system 2, the target port ID/target ID/LUN list 248 holds port IDs of those ports and one or a plurality of target IDs/LUNs assigned to the external device.

The disk controller 30 of the storage system 3 has the external device management information 302 which is similar to the external device management information 202 described above. The storage system 4 (not shown) also has similar external device management information.

Described next is the storage manager 101 run on the management server 10, which manages the SAN 5.

FIG. 5 shows an example of management information owned by the storage manager 101 of the management server 10 to manage the storage systems 2 to 4. The storage manager 101 creates, for each of the storage systems 2 to 4, a management table composed of path management information, volume management information, inter-volume connection information, external connection management information, and like other information. The created management table is put in a memory (not shown) or the like.

In FIG. 5, a management table 103a shows management information of the storage system 2, a management table 103c shows management information of the storage system 4, and a management table 103b shows management information of the newly added storage system 3. The management table 103b is created by the storage manager 101 after the storage system 3 is physically connected to the SAN 5. The management tables 103a to 103c have the same configuration and therefore only the management table 103a of the storage system 2 out of the three tables will be described below.

The management table 103a of the storage system 2 which is managed by the storage manager 101 has several types of management information set in the form of table. The management information set to the management table 103a includes path management information 105a, which is information on paths of volumes in the disk unit 21, volume management information 106a, which is for managing the state of each volume in the storage system 2, inter-volume connection management information 107a, which is for setting the relation between volumes in the storage system 2, and external connection management information 108a, which is information on a connection with an external device of the storage system.

Shown here is a case where the disk unit 21 of the storage system 2, which is the migration source, has six volumes G to L as in FIG. 1. In the following description, the ports 23a and 23b of the storage system 2 are referred to as ports G and H, respectively, the port 43a of the storage system 4 is referred to as port Z, and the ports 33a and 33b of the newly added storage system 3 are referred to as ports A and B, respectively.

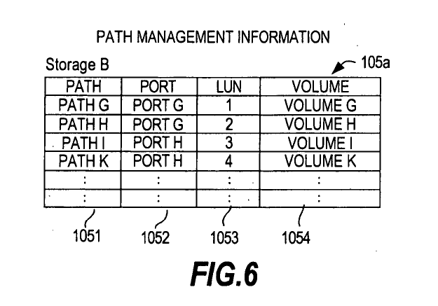

FIG. 6 is a configuration diagram of the path management information 105a set to the storage system 2. A path name 1051 is a field to store the name or identifier of a path set to the disk unit 21. A port name (or port identifier) 1052, a LUN 1053 and a volume name (or identifier) 1054 are respectively fields to store the name (or identifier) of a port, the number of a logical unit, and the name (or identifier) of a volume to which the path specified by the path name 1051 is linked.

For example, the volume G to which a path G is set and the volume H to which a path H is set are assigned to the port G, the volumes I to K to which paths I to K are respectively set are assigned to the port H, and no path is set to the volume L of FIG. 1 which is not listed in the table.

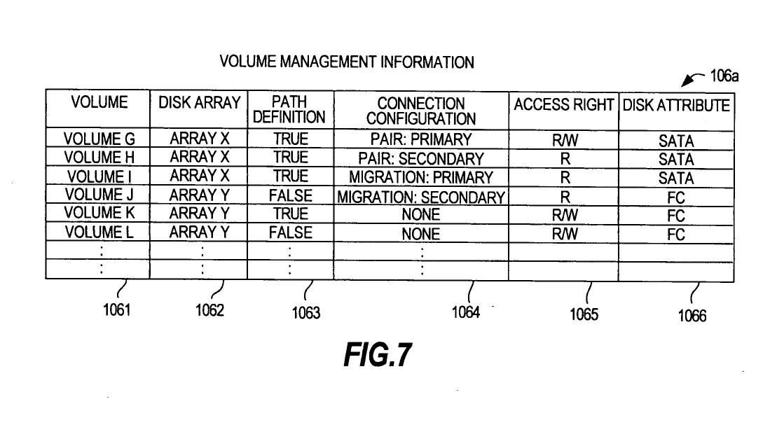

FIG. 7 is a configuration diagram of the volume management information 106a which shows the state of each volume in the storage system 2. A volume name 1061 is a field to store the name or identifier of a volume in the disk unit 21. A disk array 1062 is a field to store the identifier of an array in which the volume specified by the volume name 1061 is placed. A path definition 1063 is a field to store information on whether or not there is a path set to the volume specified by the volume name 1061. For instance, “TRUE” in the path definition 1063 indicates that there is a path set to the volume, while “FALSE” indicates that no path is set to the volume.

A connection configuration 1064 is a field to store the connection relation between the volume specified by the volume name 1061 and another volume in the disk unit 21. For instance, “pair” in the connection configuration 1064 indicates pair volume and “migration” indicates migration volume. Also shown by the connection configuration 1064 is whether the volume is primary or secondary in the connection relation. “None” is stored in this field when the volume specified by the volume name 1061 has no connection relation with other volumes. In the inter-volume connection relation called migration volume, the primary volume and the secondary volume are set in different disk arrays from each other and, when the load is heavy in the primary volume, the access is switched to the secondary volume.

An access right 1065 is a field to store the type of access allowed to the host server 11. “R/W” in the access right 1065 indicates that the host server 11 is allowed to read and write, “R” indicates that the host server 11 is allowed to read but not write, “W” indicates that the host server 11 is allowed to write but not read.

A disk attribute 1066 is a field to store an indicator that indicates the performance or reliability of a physical disk to which the volume specified by the volume name 1061 is assigned. In the case where the indicator is an interface of the physical disk, for example, “FC”, “SATA (Serial AT Attachment)”, “ATA (AT Attachment)”, or the like serves as the indicator. FC as the disc attribute 1066 indicates high performance and high reliability, while SATA or ATA indicates large capacity and low price. In the example of FIG. 7, the volumes G to I are in a disk array X, the volumes J to L are in a disk array Y, the volumes G and H are paired to constitute pair volumes, the volumes I and J constitute migration volumes, and no path is set to the volume L. FIG. 7 also shows that the disk array X is composed of SATA, while the disk array Y is composed of SCSI, and that the disk array Y has higher performance than the disk array X.

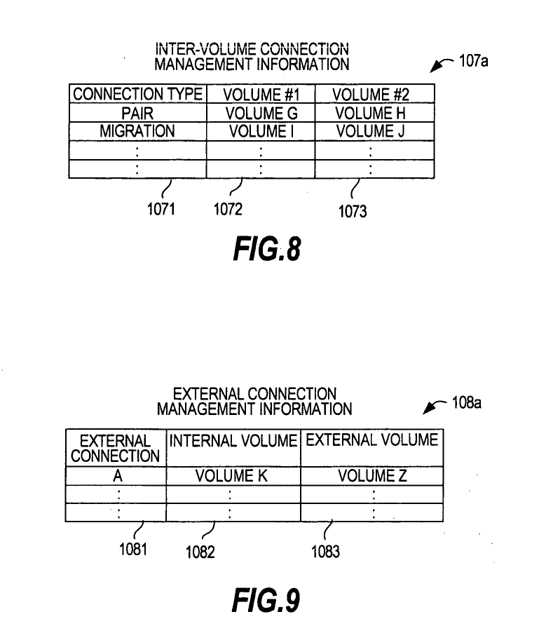

FIG. 8 is a configuration diagram of the inter-volume connection management information 107a which shows the connection relation between volumes in the storage system 2. A connection type 1071 is a field to store the type of connection between volumes, for example, “pair” or “migration”. A volume name 1072 is a field to store the name or identifier of a primary volume, while a volume name 1073 is a field to store the name or identifier of a secondary volume. FIG. 8 corresponds to FIG. 7 and the volume G which serves as the primary volume of pair volumes is stored in the volume name 1072, while the volume H which serves as the secondary volume of the pair volumes is stored in the volume name 1073. Similarly, the volume I which serves as the primary volume of migration volumes is stored in the volume name 1072, while the volume J of the migration volumes is stored in the volume name 1073.

FIG. 9 is a configuration diagram of the external connection management information 108a which shows the connection relation between a volume of the storage system 2 and an external storage system. An external connection 1081 is a field to store the identifier of an external connection. An internal volume 1082 is a field to store the name or identifier of a volume in the disk unit 21, and an external volume 1083 is a field to store the name or identifier of a volume contained in a device external to the storage system 2. In the case where the volume K of the storage system 2 is connected to a volume Z of the storage system 4, for example, as shown in FIG. 9, the volume K is stored in the internal volume name 1081 and the volume Z of the storage system 4 is stored in the external volume name 1082.

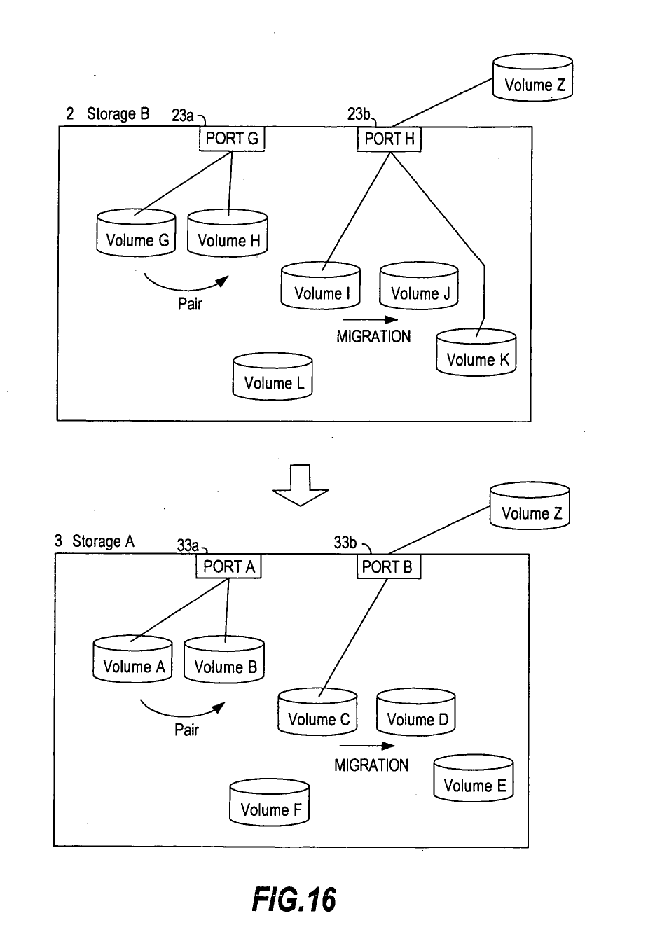

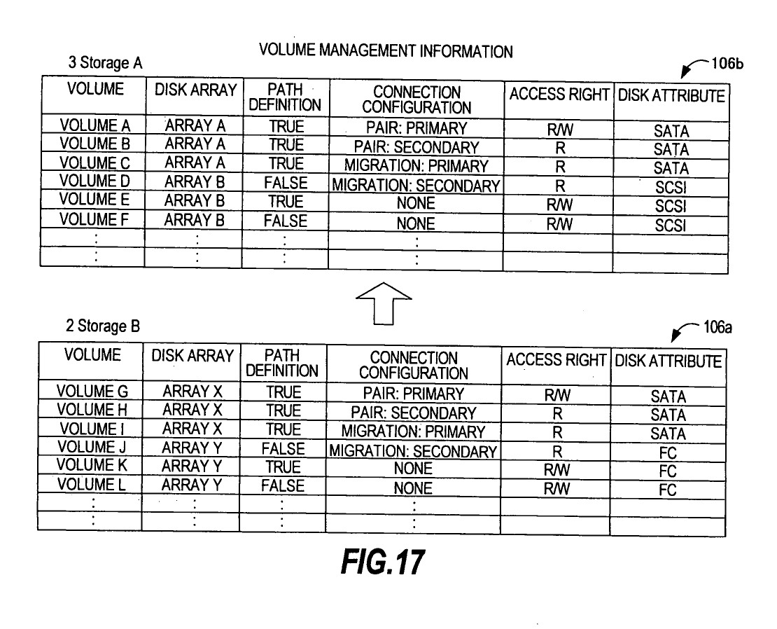

The management table 103a of the storage system 2 has the configuration described above. According to the above setting, which is illustrated in the upper half of FIG. 16, the volumes G and H assigned to the port G are paired to constitute pair volumes, the volumes I and J assigned to the port H constitute migration volumes, and the volume K assigned to the port H is connected to the external volume Z.

The storage manager 101 creates the management table 103b of the storage system 3 and the management table 103c of the storage system 4 in addition to the management table 103a of the storage system 2. The management table 103b of the storage system 3 has, as does the management table 103a described above, path management information 105b, volume management information 106b, inter-volume connection management information 107b and external connection management information 108b set thereto, though not shown in the drawing.

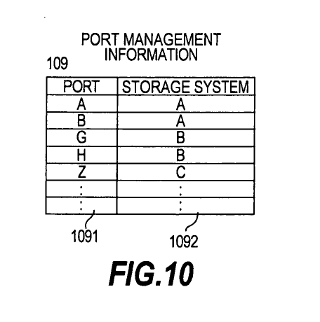

As shown in FIG. 10, the storage manager 101 has port management information 109 to manage ports of the storage systems 2 to 4. The storage manager 101 stores the identifier (ID or name) of a port and the identifier (ID or name) of a storage system to which the port belongs in fields 1091 and 1092, respectively, for each port on the SAN 5 that is notified from the FC switch 18 or detected by the storage manager 101.

A description is given below on the operation a storage administrator and the computer system, which takes upon introduction of the storage system 3.

In this embodiment, as shown in FIG. 16, data and volume configurations of the existing storage system 2 (storage system B) are copied to the newly introduced storage system 3 (storage system A), and access from the host server 11 to the storage system 2 is switched to the storage system 3.

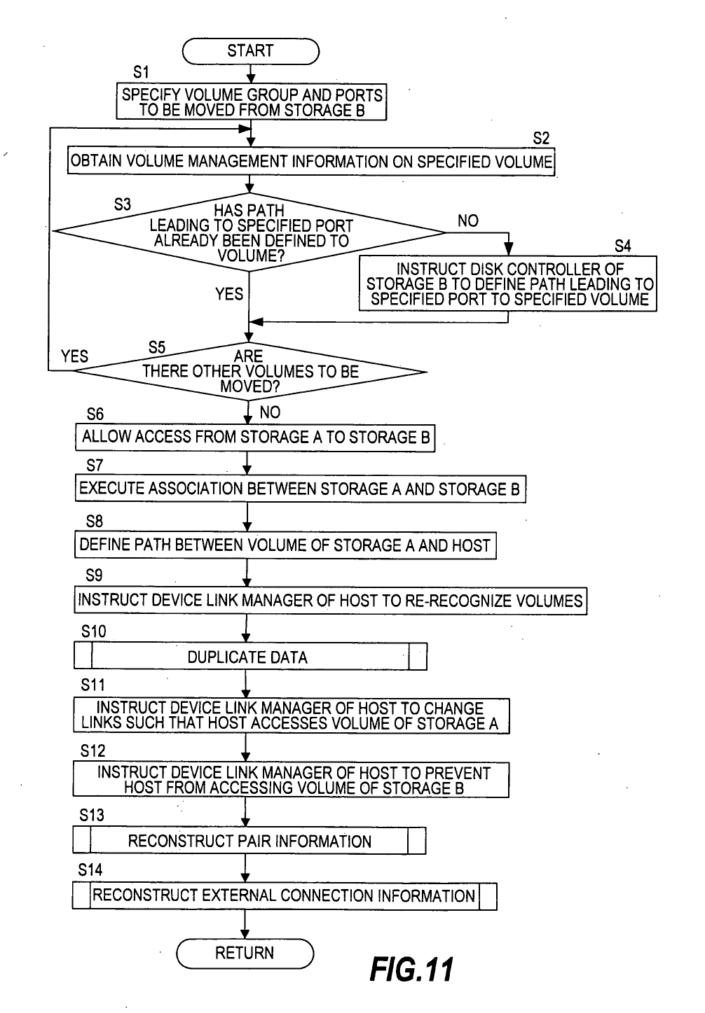

FIG. 11 is a flow chart showing an example of control executed by the migration controller 102, which is included in the storage manager 101 of the management server 10, to switch from the existing storage system 2 to the new storage system 3. It should be noted that the storage system 3 had been physically connected to the SAN 5 prior to start executing this control.

Specifically, in this embodiment, the port A (33a) of the storage system 3 is connected to the port 182 of the FC switch 18 and the port 33b is connected, as an access port to other storage systems including the storage system 2, with the port 183 of the FC switch 18. As the storage system 3 is activated, the FC switch 18 detects that a link with the ports 33a and 33b of the newly added storage system 3 has been established. Then the Fibre Channel standard is followed by the ports 33a and 33b to log into the switch 18 and onto the interfaces and ports of the host server 11 and of the storage system 2. The storage system 3 holds WWN, ID or other similar information of ports of the host server 11 or the like that the ports 33a and 33b have logged into. Upon receiving a state change notification from the FC switch 18, the migration controller 102 of the storage manager 101 obtains network topology information once again from the FC switch 18 and detects a new registration of the storage system 3. The storage manager 101 then creates or updates the port management information 109, which is for managing ports of storage systems, as shown in FIG. 10.

Once the storage manager 101 recognizes the new storage system 3 in the manner described above, the migration controller 102 can start the control shown in FIG. 11.

First, in a step S1 of FIG. 11, a volume group and ports that are to be moved from the storage system 2 (storage system B in the drawing) to the storage system 3 (storage system A) are specified. A storage administrator, for example, specifies a volume group and ports to be moved using a console (not shown) or the like of the management server 10.

The storage manager 101 stores information of the specified volumes and port of the storage system 2, which is the migration source, in separate lists (omitted from the drawing), and performs processing of a step S2 and of the subsequent steps on the specified volumes and ports starting with the volume and the port at the top of their respective lists.

In the step S2, the storage manager 101 reads the volume management information 106a of the storage system 2 which is shown in FIG. 7 to sequentially obtain information of the specified volumes from the volume configuration of the storage system 2 as the migration source.

In a step S3, the storage manager 101 judges whether or not a path corresponding to the port that has been specified in the step S1 is defined to the volume of the storage system 2 that has been specified in the step S1. To make a judgment, whether there is a path defined or not is first judged by referring to the volume name 1061 and path definition 1063 of FIG. 7. When there is a path defined, the path management information 105a of FIG. 6 is searched with the volume name as a key to obtain a corresponding port name. In the case where the obtained port name matches the name of the port specified in the step S1, it means that a path is present and the procedure proceeds to a step S5. On the other hand, when there is no path defined or the obtained port name does not match the name of the port specified in the step S1, it means that no path is present and the procedure proceeds to a step S4.

In the step S4 where no path is present, the storage manager 101 instructs the disk controller 20 of the storage system 2 to define the specified path to this volume. Then the storage manager 101 updates the path management information 105a of the storage system 2 by adding a path that is temporarily set for migration. The procedure is then advanced to processing of the step S5.

In the step S5, it is judged whether or not checking on path definition has been completed for every volume specified in the step S1. When every specified volume has been checked out for a path defined, the procedure is advanced to processing of a step S6. On the other hand, in the case where the checking has not been completed, it means that there are still volumes left that have been chosen to be moved, the procedure returns to the step S2 and the processing of the steps S2 to S5 is performed on the next specified volume on the list.

In the step S6, the storage manager 101 changes the zoning setting of the FC switch 18 and changes the device access right setting of the storage system 2 in a manner that enables the storage system 3 to access volumes of the storage system 2.

In a step S7, the storage manager 101 allocates volumes of the storage system 2 to volumes of the new storage system 3 to associate the existing and new storage systems with each other on the volume level.

Specifically, the storage manager 101 first sends, to the storage system 3, a list of IDs of ports of the storage system 2 that are to be moved to the storage system 3 (for example, the port management information of FIG. 10). Receiving the list, the disk controller 30 of the storage system 3 sends, from the port B (33b), a SCSI Inquiry command with a specific LUN designated to the ports 23a and 23b of the storage system 2 which are in the received list for every LUN. In response, the disk controller 20 of the storage system 2 returns a normal response to an Inquiry command for the LUN that is actually set to each port ID of the storage system 2.

The disk controller 30 of the storage system 3 identifies, from the response, volumes of the storage system 2 that are accessible and can be moved to the storage system 3 to create an external device list about these volumes (an external device list for the storage system 3). The disk controller 30 of the storage system 3 uses information such as the name of a device connected to the storage system 3, the type of the device, or the capacity of the device to judge whether a volume can be moved or not. The information such as the name of a device connected to the storage system 3, the type of the device, or the capacity of the device is obtained from return information of a response to the Inquiry command and from return information of a response to a Read Capacity command, which is sent next to the Inquiry command. The disk controller 30 registers volumes of the storage system 3 that are judged as ready for migration in the external device management information 302 as external devices of the storage system 3.

Specifically, the disk controller 30 finds an external device for which “unmounted” is recorded in the device state 244 of the external device management information 302 shown in FIG. 4, and sets the information 242 to 248 to this external device entry. Then the device state 244 is changed to “offline”.

The disk controller 30 of the storage system 3 sends the external device list of the specified port to the storage manager 101. The migration controller 102 of the storage manager 101 instructs the storage system 3 to allocate the volumes of the storage system 2.

Receiving the instruction, the disk controller 30 of the storage system 3 allocates an external device a, namely, a volume of the storage system 2, to an unmounted volume a of the storage system 3.

Specifically, the disk controller 30 of the storage system 3 sets the device number 241 of the external device a, which corresponds to a volume of the storage system 2, to the corresponding physical/external device number 23 in the volume management information 201 about the volume a, and changes the device state 224 in the volume management information 301 from “unmounted” to “offline”. The disk controller 30 also sets the device number 221 of the volume a to the corresponding volume number 243 in the external device management information 302 and changes the device state 244 to “offline”.

In a step S8, the migration controller 102 of the storage manager 101 instructs the storage system 3 to define an LUN to the port 33a in a manner that makes the volume a, which is allocated to the storage system 3, accessible to the host server 11, and defines a path.

Receiving the instruction, the disk controller 30 of the storage system 3 defines, to the port A (33a) or the port B (33b) of the storage system 3, an LUN associated with the previously allocated volume a. In other words, a device path is defined. Then the disk controller 30 sets the port number/target ID/LUN 225 and the connected host name 226 in the volume management information 301.

When allocating a volume of the storage system 2 as a volume of the storage system 3 and defining an LUN are finished, the procedure proceeds to a step S9 where the migration controller 102 of the storage manager 101 instructs the DLM 111 of the host server 11 to re-recognize devices.

Receiving the instruction, the DLM 111 of the host server 11 creates a device file about the volume newly allocated to the storage system 3. For instance, in the UNIX operating system, a new volume is recognized and its device file is created upon an “IOSCAN” command.

When the newly created device file is the same as the device file created in the past about the corresponding volume of the storage system 2, the DLM 111 detects the fact and manages these device files in the same group. One way to detect that the two device files are the same is to obtain the device number in the storage system 3 with the above-described Inquiry command or the like. However, when the volume a in the storage system 3 corresponds to the volume b in the storage system 2, the volumes a and b are viewed by the DLM 111 as volumes of different storage systems 2 to 4 and are accordingly not managed in the same group.

In a step S10, after the storage system 3 is introduced to the computer system, data stored in a device in the storage system 2 is duplicated to a free volume in the storage system 3.

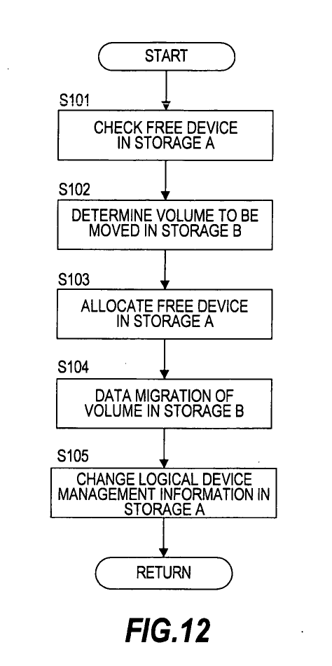

This processing will be described with reference to a subroutine of FIG. 12.

First, the migration controller 102 of the storage manager 101 instructs the disk controller 30 of the storage system 3 to duplicate data. The disk controller 30 of the storage system 3 checks, in a step S101 of FIG. 12, the device state 234 in the RAID management information 303 to search for the physical device a that is in an “offline” state, in other words, a free state. Finding an “offline” physical device, the disk controller 30 consults the size 232 to obtain the capacity of the free device. The disk controller 30 searches in a step S102 for an external device for which “offline” is recorded in the device state 244 of the external device management information 302 and the size 242 of the external device management information 302 is within the capacity of this physical device a (hereinafter such external device is referred to as migration subject device).

As the free physical device a to which data is to be duplicated and the migration subject device are determined, the disk controller 30 allocates in a step S103 the free physical device to the volume a of the storage system 3.

Specifically, the number of the volume a is registered as the corresponding volume number 233 in the RAID management information 303 that corresponds to the physical device a, and the device state 234 is changed from “offline” to “online”. Then, after initializing the data migration progress pointer 228 in the volume management information 301 that corresponds to the volume a, the device state 24 is set to “mid-data migration”, the mid-data migration flag 229 is set to “On”, and the number of the physical device a is set as the mid-migration physical/external device number 227.

When the device allocation is completed, the disk controller 30 of the storage system 3 carries out, in a step S104, data migration processing to duplicate data from the migration subject device to the physical device a. Specifically, data in the migration subject device is read into the cache 224 and the read data is written in the physical device a. This data reading and writing is started from the head of the migration subject device and repeated until the tail of the migration subject device is reached. Each time writing in the physical device a is finished, the header address of the next migration subject region is set to the data migration progress pointer 228 about the volume a in the volume management information 301.

As every data transfer is completed, the disk controller 30 sets in a step S105 the physical device number of the physical device a to the corresponding physical/external device number 223 in the volume management information 301, changes the device state 224 from “mid-data migration” to “online”, sets the mid-data migration flag 229 to “Off”, and sets an invalidating value to the mid-migration physical/external device number 227. Also, an invalidating value is set to the corresponding volume number 243 in the external device management information 302 that corresponds to the migration subject device and “offline” is set to the device state 244.

Next, in S11, the migration controller 102 of the storage manager 101 instructs the DLM 111 of the host server 11 to change the access destination from the storage system 2 to the new storage system 3.

Receiving this instruction, the DLM 111 changes the access to the volume in the storage system 2 to access to the volume in the storage system 3.

More specifically, first, the migration controller 102 of the storage manager 101 sends device correspondence information of the storage system 2 and the storage system 3 to the DLM 111. The device correspondence information is information of the assignment of the volumes of the storage system 3.

The DLM 111 of the host server 11 assigns a virtual device file that is assigned to a device file group relating to a volume in the storage system 2 to a device file group relating to a volume in the storage system 3. As a result, software operating on the host server 11 can access the volume a in the storage system 3 according to a same procedure of accessing the volume b in the storage 2.

Next, in a step S12, the migration controller 102 of the storage manager 101 makes the FC switch 18 change the zoning setting and makes the storage system 2 change setting of the device access right, to inhibit the host server 11 from directly accessing the devices of the storage system 2.

Through the above processing, the volumes A to F are set in the new storage system 3 to match the volumes G to L of the storage system 2 which is the migration source as shown in FIG. 16, and path definitions corresponding to the volumes A to F are created in the path management information 105b of the storage manager 101. Thus data stored in volumes of the storage system 2 which is the migration source is transferred to the corresponding volumes of the new storage system 3 and the new storage system 3 is made accessible to the host server 11.

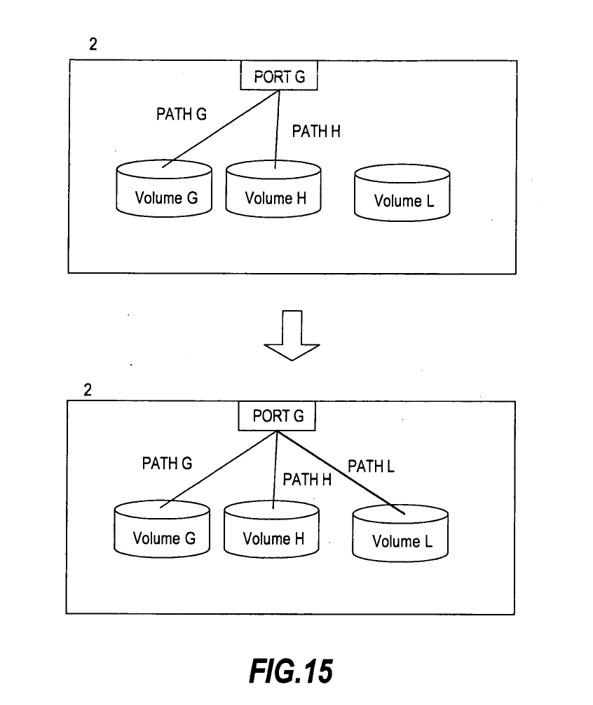

As shown in FIG. 15, when the storage system 2 which is the migration source has the volume L to which no path is set, the processing of the steps S3 and S4 temporarily set a path L for migration to thereby enable the new storage system 3 to access the volume L of the migration source. As a result, every volume in the migration source can be moved to the new storage system 3 irrespective of whether the volume has a path or not.

As volumes and data of the existing storage system 2 are moved to the new storage system 3, the inter-volume connection such as pair volume and migration volume set in the storage system 2 in the step S13 of FIG. 11 is rebuilt in the new storage system 3.

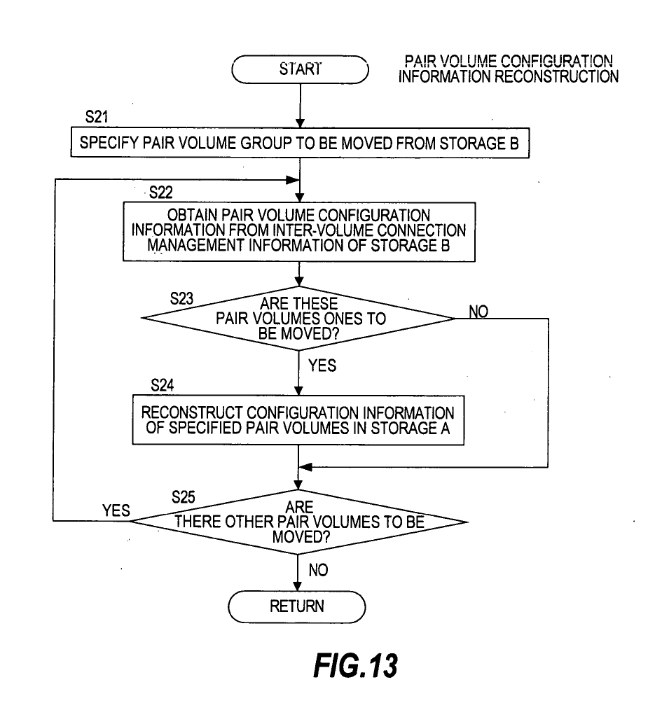

This processing will be described with reference to a subroutine of FIG. 13.

First, in a step S21, all pair volumes in the volume group specified in the step S1 are specified as volumes to be moved from the storage system 2 to the storage system 3, or an administrator or the like uses a console (not shown) of the storage manager 101 to specify migration volumes.

In a step S22, the migration controller 102 of the storage manager 101 obtains the inter-volume connection management information 107a of the storage system 2 which is shown in FIG. 8 to obtain pair volumes in the storage system 2 which is the migration source.

In a step S23, when the volume specified in the step S21 is in the inter-volume connection management information 107a of the storage system 2, the procedure proceeds to a step S24 where the type of connection and primary-secondary connection between relevant volumes are created in the inter-volume connection management information 107b. The storage manager 101 then notifies the disk controller 30 of the storage system 3 which is the migration destination of the pair relation rebuilt via the LAN 142.

In the step S25, the loop from the steps S22 to S24 is repeated until searching the inter-volume connection management information 107a of the storage system 2 is finished for every pair volume specified in the step S21. When inter-volume connection information that corresponds to the migration relation in the storage system 2 is created in the inter-volume connection management information 107b of the storage system 3 for all the specified volumes that are in a migration relation, the subroutine is ended.

Through the above subroutine, the migration relation of the pair volumes G and H in the storage system 2 which is the migration source is set to the volumes A and B in the new storage system 3 as shown in FIG. 16, the inter-volume connection management information 107b and volume management information 106b of the storage manager 101 are updated, and the pair information is sent to the disk controller 30 of the new storage system 3. Thus migration volumes in the migration source can automatically rebuild in the new storage system 3. Migration volumes may be specified in the step S1 instead of the step S31.

After a pair relation in the same storage system is rebuilt in the new storage system 3, the procedure proceeds to a step S14 of FIG. 11 where connection information of migration volumes in the storage system 2 which is the migration source is reconstructed in the storage system 3.

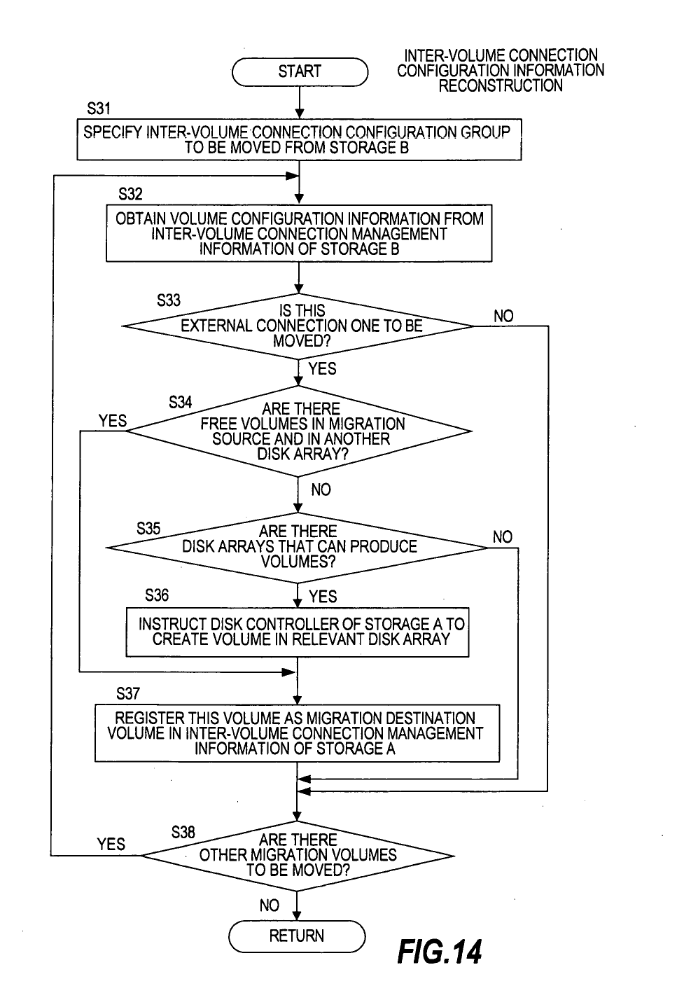

This processing will be described with reference to a subroutine of FIG. 14. Unlike rebuilding of the pair relation in FIG. 13, reconstruction of connection information of migration volumes needs to adjust the volume-disk array relation since a primary volume and secondary volume of migration volumes have to be in different disk arrays from each other.

First, in a step S31, all migration volumes in the volume group specified in the step S1 are specified as volumes to be moved from the storage system 2 to the storage system 3, or an administrator or the like uses a console (not shown) of the storage manager 101 to specify migration volumes.

In a step S32, the migration controller 102 of the storage manager 101 obtains the inter-volume connection management information 107a of the storage system 2 which is shown in FIG. 8 to obtain migration volumes in the storage system 2 which is the migration source.

In a step S33, when the migration volumes specified in the step S31 are found in the inter-volume management information 107a of the storage system 2, the procedure proceeds to a step S34. If not, the procedure proceeds to a step S38.

In a step S34, the volume management information 106b is consulted to judge whether or not a disk array that is not the migration source (primary volume) has a volume that can serve as a migration destination (secondary volume). When this disk array has a free volume that can serve as a migration destination volume, the procedure proceeds to a step S37, while the procedure is advanced to a step S35 when the disk array has no free volume.

In the step S35, it is judged whether or not the storage system 3 which is the migration destination has a disk array that can produce a volume. To make a judgment, the RAID management information 303 and logical device management information 301 shown in FIG. 3 are consulted to search for disk arrays that can produce migration volumes of the storage system 2 which is the migration source. When there are disk arrays that can produce migration volumes, the procedure proceeds to a step S36 where the disk controller 30 of the storage system 3 is instructed to create volumes in the disk arrays. Following FIG. 12, data is moved to the new volumes from the migration volumes of the storage system 2 which is the migration source.

With the instruction, the volume management information of the storage system 2 which is the migration source is consulted to choose a disk attribute relation in a manner that makes the attribute relation between disks having migration volumes in the migration source reproducible in the storage system 3 which is the migration destination. For instance, when the disk attribute of a migration volume I (primary volume) in the migration source is “SATA” and the disk attribute of a secondary volume J in the migration source is “FC”, higher performance is chosen for the disk attribute of a secondary migration volume D in the storage system 3 which is the migration destination than the disc attribute of a primary migration volume C in the storage system 3. In this way, the difference in performance between the primary volume and secondary volume of migration volumes can be reconstructed.

On the other hand, when there are no disk arrays that can produce migration volumes, the procedure proceeds to the step S38. At this point, or thereafter, an error message may be sent which says that the primary volume and secondary volume of migration volumes cannot be set in different disk arrays.

After the primary volume and secondary volume of migration volumes are set in different disk arrays in the step S36, the primary volume and the secondary volume are registered in the step S37 in the inter-volume connection management information 106b of the storage system 3 with the connection type set to “migration”. The migration relation is notified to the disk controller 30 of the storage system 3.

In the step S38, the loop from the steps S32 to S37 is repeated until searching the inter-volume connection management information 107a of the storage system 2 is finished for every migration volume specified in the step S31. When inter-volume connection information that corresponds to the migration relation in the storage system 2 is created in the inter-volume connection management information 107b of the storage system 3 for all the specified volumes that are in a migration relation, the subroutine is ended.

Through the above subroutine, as shown in FIG. 16, the migration relation of the migration volumes I and J in the storage system 2 which is the migration source is set to the volumes C and D in the new storage system 3, the inter-volume connection management information 107b and volume management information 106b of the storage manager 101 are updated, and the migration information is sent to the disk controller 30 of the new storage system 3. Thus migration volumes in the storage system 2 which is the migration source can automatically rebuilt in the new storage system 3. Migration volumes may be specified in the step S1 instead of the step S31.

As the above processing is completed, the storage manager 101 instructs the disk controllers 20 and 30 to remove the temporary path created for a volume that has no path set, and updates the path management information 105 of the relevant storage system to end processing.

The processing of FIGS. 11 to 14 makes it possible to move volumes and path definitions in the storage system 2 which is the migration source to the new storage system 3 while ensuring that necessary volumes are moved to the new storage system 3 irrespective of whether or not a path is defined in the storage system 2 which is the migration source. In addition, inter-volume connection information can automatically be moved to the new storage system 3, which greatly saves the storage administrator the labor of introducing the new storage system 3. Moreover, the host server 11 can now access and utilize the new storage system 3 which is superior in performance to the existing storage system 2.

In the case where a volume of the storage system 2 is connected to a device external to the storage system 2 (for example, the volume Z of the storage system 4) in the step S8 of FIG. 11 where a path is defined, the external connection management information 108a shown in FIG. 9 is consulted to define a path between the external volume and a volume of the new storage system 3. The internal volume and the external volume are set in the external connection management information 108b shown in FIG. 9 when the external connection is completed.

This invention is summarized as follows:

First, as shown in FIG. 16, whether there is a path defined or not is checked for a migration subject volume in the storage system 2 which is the migration source, and a path for migration is temporarily defined to a volume that has no path defined.

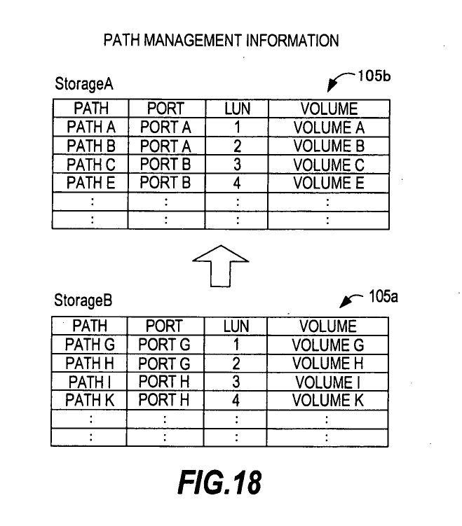

Next, volumes of the storage system 2 which is the migration source are allocated to the storage system 3 which is the migration destination to associate the storage systems with each other on the volume level. Thereafter, paths in the storage system 2 which is the migration source are moved to the storage system 3 which is the migration destination. As shown in FIGS. 17 and 18, this creates the volume management information 106b and path management information 105b of the storage system 3 in the storage manager 101. The external connection management information 108b of the storage system 3 is also created, though not shown in the drawings. However, at this point, connection configurations have not been moved to the volume management information 106b yet.

When volumes and path definitions are created in the new storage system 3, data is duplicated from the volume G of the storage system 2 which is the migration source to the volume A of the storage system 3 which is the migration destination, thereby starting sequential data transfer from migration source volumes to migration destination volumes.

As the data duplication between volumes is completed, pair volumes in the storage system 2 which is the migration source are duplicated to the new storage system 3 through the processing of FIG. 13, and migration volumes in the storage system 2 which is the migration source are moved to the new storage system 3 through the processing of FIG. 14.

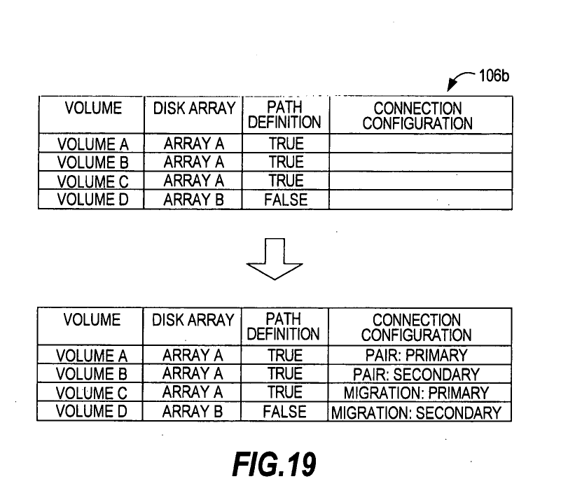

An example is shown in FIG. 19. The upper half of FIG. 19 shows the volume management information 106b of the storage system 3 at the stage where data migration is completed (the step S10), while the lower half of FIG. 19 shows the information 106b at the stage where reconstruction of pair volumes (the step S13) and reconstruction of migration volumes (the step S14) are completed. In this example, the pair volumes G and H in the migration source correspond to the pair volumes A and B in the migration destination with the pair volume A serving as the primary volume and the volume B as the secondary volume. Similarly, the migration volumes I and J in the migration source correspond to the volumes C and D in the migration destination with the volume C serving as the primary volume in the disk array A and the volume D as the secondary volume in the disk array B. The migration volumes C and D in the new storage system 3 which are a reproduction of the migration volumes I and J in the migration source are set in disk arrays whose disk attribute relation is the same as the disk attribute relation between disk arrays in which the migration volumes I and J are placed.

In this way, inter-volume connection configurations such as pair volume and migration volume, as well volumes and data, are moved from the storage system 2 which is the migration source to the new storage system 3 while a temporary path is created to ensure migration of volumes that have no paths defined from the storage system 2 as the migration source to the new storage system 3. The burden of the administrator in introducing the new storage system 3 is thus greatly reduced.

Exchange of configuration information and instruction between the storage manager 101 and the disk controller 20 or 30 uses the LAN 142 (IP network) and therefore does not affect data transfer over the SAN 5.

If the path from the storage system 3 is left in the storage system 2 which is the migration source after the processing of FIG. 11 is completed, the storage system 2 which is the migration source can be used as a mirror without any modification and the computer system can have redundancy.

Although the SAN 5 and the LAN 142 are used in the above embodiment to connect the storage systems 2 to 4, the management server 10 and the host server 11, only one of the two networks may be used to connect the storage systems and the servers.

In the above embodiment, ports to be moved are specified in the step S1 of FIG. 11. The ports can be specified either on the port-basis or on the storage system-basis.

While the present invention has been described in detail and pictorially in the accompanying drawings, the present invention is not limited to such detail but covers various obvious modifications and equivalent arrangements, which fall within the purview of the appended claims.

What is claimed is:

1. A storage system introducing method for introducing a second storage system to a computer system comprised of a first storage system and a host computer, the first storage system being connected to a network, the host computer accessing the first storage system via the network, the method comprising:
changing access right of the first storage system in a manner that allows the newly connected second storage system access to the first storage system;
detecting a path for a volume set in the first storage system;
setting, when a volume without the path is found, a path that is accessible from the second storage system to the first storage system;
allocating a volume of the first storage system to the second storage system;
defining a path in a manner that allows the host computer access to a volume of the second storage system;
duplicating data stored in a volume of the first storage system to the volume allocated to the second storage system; and
changing setting of the host computer to forward an input/output request made to the first storage system by the host computer to the second storage system.

2. The storage system introducing method according to claim 1, wherein an inter-volume connection of the first storage system is obtained, and the inter-volume connection is set to volumes of the second storage system that correspond to the inter-volume connection, after the data stored in a volume of the first storage system is transferred to the volume allocated to the second storage system.

3. The storage system introducing method according to claim 2, wherein for setting the inter-volume connection to volumes of the second storage system, when the inter-volume connection makes the host computer switch access from a primary volume to a secondary volume, volumes of the second storage system is set to make the primary volume and the secondary volume belong to different physical disks from each other.

4. The storage system introducing method according to claim 3, wherein for setting volumes of the second storage system, it is judged whether or not there is a free volume in the second storage system that can be set as the secondary volume to which the host computer switches access, and when the free volume is not found, a new volume is created and set as the secondary volume.

5. A program for a computer system comprised of a first storage system, a host computer, and a management computer to make the management computer execute processing of introducing a second storage system to the computer system, the first storage system being connected to a network, the host computer accessing the first storage system via the network, the management computer managing the first storage system via the network, the second storage system being connected to the network,
the program controlling the management computer to execute:
processing of instructing the first storage system to change access right in a manner that allows the second storage system access to the first storage system;
processing of detecting a path for a volume set in the first storage system;
processing of setting, when a volume without the path is found, a path that is accessible from the second storage system to the first storage system;
processing of instructing the second storage system to allocate a volume of the first storage system to the second storage system;
processing of instructing the second storage system to define a path in a manner that allows the host computer access to a volume of the second storage system;
processing of instructing the second storage system to duplicate data stored in a volume of the first storage system to the volume allocated to the second storage system; and
processing of instructing the host computer to change setting to forward an input/output request made to the first storage system by the host computer to the second storage system.

6. The program according to claim 5, wherein processing of obtaining an inter-volume connection of the first storage system and processing of instructing the second storage system to set the inter-volume connection to volumes of the second storage system that correspond to the inter-volume connection are put after the processing of instructing the second storage system to duplicate data stored in a volume of the first storage system to the volume allocated to the second storage system.

7. The program according to claim 6, wherein the processing of instructing the second storage system to set the inter-volume connection to volumes of the second storage system includes processing of instructing the second storage system to set, when the inter-volume connection makes the host computer switch access from a primary volume to a secondary volume, volumes of the second storage system in a manner that makes the primary volume and the secondary volume belong to different physical disks from each other.

8. The program according to claim 7, wherein the processing of instructing the second storage system to set volumes of the second storage system includes:
processing of judging whether or not there is a free volume in the second storage system that can be set as the secondary volume to which the host computer switches access; and
processing of instructing the second storage system to create, when the free volume is not found, a new volume and set the new volume as the secondary volume.

9. A management computer for a computer system comprised of a first storage system, a host computer, and a second storage system to move data in the first storage system to the second storage system, the first storage system being connected to a network, the host computer accessing the first storage system via the network, the second storage system being newly connected to the network, the management computer comprising:
a volume managing module which manages configuration information of volumes set in the first storage system and the second storage system;
a path managing module which manages information on paths set in the first storage system and the second storage system; and
a migration module which carries out migration from the first storage system to the second storage system when the second storage system is connected to the network,
wherein the migration module comprises:
a migration path setting module which uses the volume configuration information of the volume managing module and the path information of the path managing module to detect a volume that has no path defined out of volumes set in the first storage system and to set a path to this volume;
an access right changing module which instructs the first storage system to change access right of the first storage system in a manner that allows the second storage system access to the first storage system;
a volume allocating module which allocates a volume in the first storage system to the second storage system and updates the configuration information of the volume managing module;
an introduction path setting module which sets a path to a volume in the second storage system in a manner that allows the host computer access to the volume in the second storage system and which updates the path information of the path managing module;
a data migration module which instructs the second storage system to duplicate data stored in a volume of the first storage system to the volume allocated to the second storage system; and
a migration finishing module which instructs the host computer to change setting to forward an input/output request made to the first storage system by the host computer to the second storage system.

10. The management computer according to claim 9,
wherein the management computer further comprises an inter-volume connection managing module which manages configuration information on an inter-volume connection set to the first storage system and the second storage system, and
wherein the migration module comprises an inter-volume connection migration module which obtains an inter-volume connection of the first storage system based on the configuration information of the inter-volume connection managing module and sets the inter-volume connection to volumes in the second storage system that correspond to the inter-volume connection.

11. The management computer according to claim 10,
wherein the inter-volume connection managing module contains, in the configuration information, a primary volume-secondary volume relation of an inter-volume connection, and
wherein the inter-volume connection migration module sets a secondary volume of an inter-volume connection in the first storage system to the second storage system.

12. The management computer according to claim 11, wherein, when the second storage system has no free volume that can be set as a secondary volume of an inter-volume connection in the first storage system, the inter-volume connection migration module instructs the second storage system to create the free volume.

13. The management computer according to claim 11, wherein when the inter-volume connection makes the host computer switch access from a primary volume to a secondary volume, the inter-volume connection migration module sets the secondary volume to a volume of a physical device in the second storage system that is different from a physical disk where the primary volume is set.
